(19) United States
(12) Patent Application Publication
(10) Pub. No.: US 2020/0197960 A1
(43) Pub. Date: Jun. 25, 2020

(54) OUTLET DEVICE AND SHOWER HEAD

(71) Applicant: XIAMEN SOLEX HIGH-TECH INDUSTRIES CO., LTD., Xiamen (CN)

(72) Inventors: Daqiang ZHANG, Xiamen (CN); Chunjie HONG, Xiamen (CN); Yusheng LIN, Xiamen (CN)

(73) Assignee: XIAMEN SOLEX HIGH-TECH INDUSTRIES CO., LTD., Xiamen (CN)

(21) Appl. No.: 16/433,673

(22) Filed: Jun. 6, 2019

(30) Foreign Application Priority Data
Dec. 19, 2018 (CN) 201811555382.9

(51) Int. Cl. B05B 1/16; B05B 1/18; B05B 3/04

(52) U.S. Cl. CPC B05B 1/1636; B05B 3/04; B05B 1/185

(57) ABSTRACT

The present invention provides an outlet device, which comprises a main body, a slanting water body, a rotating driving element and a blocking element; one side of the main body is the inlet end, the other side is disposed with a plurality of outlet holes; the slanting water body, the rotating driving element and the blocking element are disposed in the main body; the slanting water body is disposed with a slanting outlet hole with one end connected to the inlet end and the other end connected to the rotating driving element; water flows from the slanting outlet hole to the rotating driving element and drives the rotating driving element to rotate, the rotating driving element drives the blocking element to rotate synchronously; the blocking element blocks a part of the outlet holes during the rotating and makes the position of the outlet holes in outlet state change with the rotation of the blocking element, and water flows out of the outlet device in spiral shape to form rhythmic water.

### TECHNICAL FIELD

The present invention relates to sanitary ware, in particular to an outlet device.

### RELATED ART

At present, in order to realize dynamic water splash, the kitchen shower head generally deviates its outlet hole of bubble water from the center position of the cover to make room for the moving parts, so that the outlet position of the bubble water is eccentric, and the vision is awkward. Moreover, the shower cover has a large area, the diameter is more than 50 mm, and the appearance of the cover is not very attractive.

### SUMMARY OF THE INVENTION

The main technical problem to be solved by the present invention is to provide an outlet device capable of generating rhythmic water to increase the impact force of the water.

In order to solve the above technical problems, the present invention provides an outlet device, wherein comprising a main body, a slanting water body, a rotating driving element and a blocking element;

One side of the main body is the inlet end, the other side is disposed with a plurality of outlet holes; the slanting water body, the rotating driving element and the blocking element are disposed in the main body; the slanting water body is disposed with a slanting outlet hole with one end connected to the inlet end and the other end connected to the rotating driving element;

Water flows from the slanting outlet hole to the rotating driving element and drives the rotating driving element to rotate, the rotating driving element drives the blocking element to rotate synchronously; the blocking element blocks a part of the outlet holes during the rotating and makes the position of the outlet holes in outlet state change with the rotation of the blocking element, and water flows out of the outlet device in spiral shape to form rhythmic water.

In another preferred embodiment, the rotating driving element is an impeller with blades arranged with space in the periphery; the block is a block plate connected between the blades.

In another preferred embodiment, the block plate forms a acute angle to the blade.

In another preferred embodiment, the outlet holes are arranged in a circle, the area of the block plate is a half of the periphery of the external side wall of the water hole, making the block plate blocks a half of the outlet holes.

In another preferred embodiment, the intersection angle of the slanting outlet hole and the blade ranges from 70-110°.

In another preferred embodiment, the slanting outlet holes are arranged along the circumferential direction of the slanting water body, and the smaller the number of the slanting outlet holes is, the faster the rotation speed of the impeller rotates.

The present invention further provides a shower head, comprising a shower head body, wherein the front end of the shower head body is assembled with the outlet device above mentioned.

In another preferred embodiment, the main body of the outlet device is further disposed with a straight flush water outlet at the axial center, and the water outlet holes are distributed at the periphery of the straight flush water outlet; the center of the impeller and the slanting water body respectively have a water flowing hole, and the water flows out of the straight flush water outlet through the water flowing holes.

In another preferred embodiment, the straight flush water outlet is disposed with a bubbler.

In another preferred embodiment, further comprising a switch device, the switch device comprises an operation element, a sealing element and a spindle; the spindle is disposed with a first passage connected to the water flowing hole and a second passage connected to the slanting outlet holes; the operation element drives the sealing element to move to close the first passage or the second passage.

1. The present invention provides an outlet device that the block plate of the impeller blocks a part of the outlet holes, so that only a part of outlet holes have water flowing out of the outlet device all the time, and the water outlet portion rotates with the rotation of the block plate of the impeller to form a dynamic spiral water, namely rhythmic water; as water flows out of only a part of the water outlet holes, the impact force of each water hole is stronger; and due to the dynamic effect of the water, the cleaning area of the rhythmic water does not decrease, the rhythmic water has characteristic of intermittent, so the rhythmic water has a vibration function with a better cleaning effect.

2. The present invention provides an outlet device that the slanting outlet hole of the slanting water body and the blade of the impeller are at an angle ranging from 70°-110°, and the energy of the water flow is maximized to drive the impeller to rotate.

3. The present invention provides an outlet device that the blade of the impeller and the block plate are at an angle and the angle is an acute angle. Inclining the blades of the impeller reduces the resistance between the impeller and the water.

### BRIEF DESCRIPTION OF THE DRAWINGS

FIG. 1 is a perspective view of a shower head in a preferred embodiment of the present invention;

FIG. 2 is an exploded view of the shower head in a preferred embodiment of the present invention;

FIG. 3 is a water circuit diagram of the shower head when bubble water flows out of the shower head in a preferred embodiment of the present invention;

FIG. 4 is a water circuit diagram of a shower when rhythmic water flows out of the shower head in a preferred embodiment of the present invention;

FIG. 5 is a cross-sectional view of the slanting water body and the impeller in a preferred embodiment of the present invention;

FIG. 6 is a schematic view showing the rotation of the impeller in a preferred embodiment of the present invention;

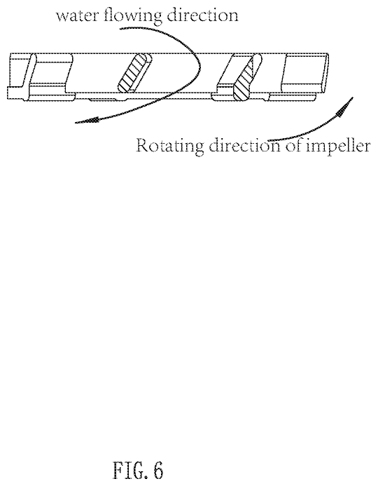

FIG. 7 is a perspective view of the impeller in a preferred embodiment of the present invention;

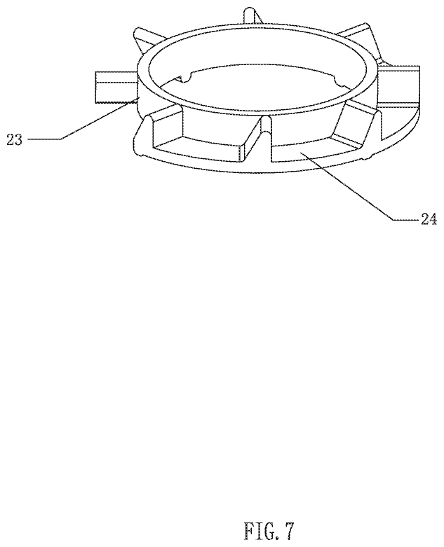

FIG. 8 is a plan view of the impeller in a preferred embodiment of the present invention;

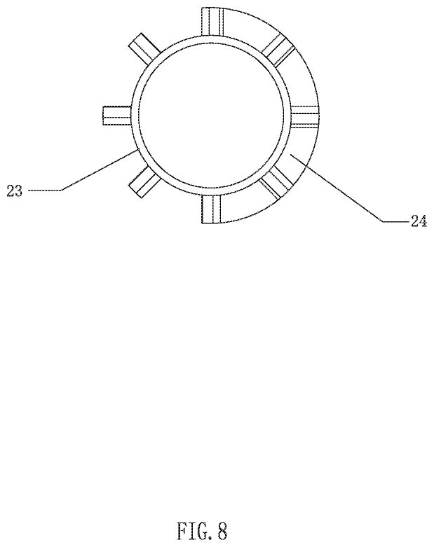

FIG. 9 is a side view of the impeller in a preferred embodiment of the present invention;

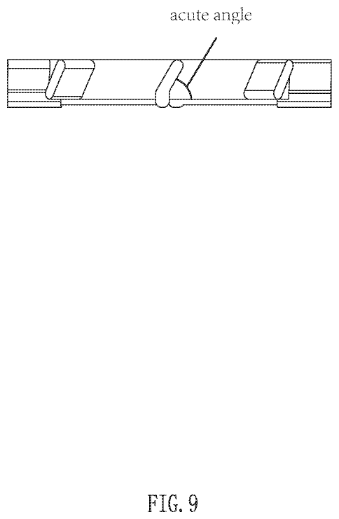

FIG. 10 is a perspective view of a slanting water body in a preferred embodiment of the present invention.

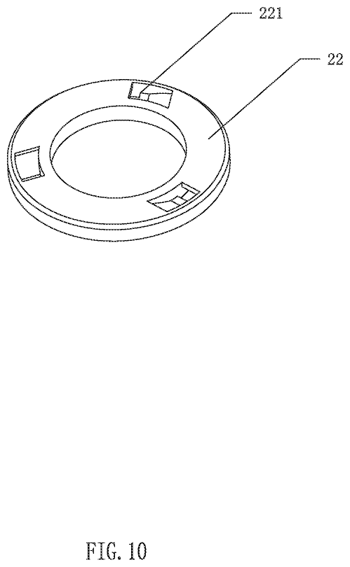

### DETAILED DESCRIPTION OF THE EMBODIMENTS

The technical solution of the present invention will be further described below in conjunction with the embodiments.

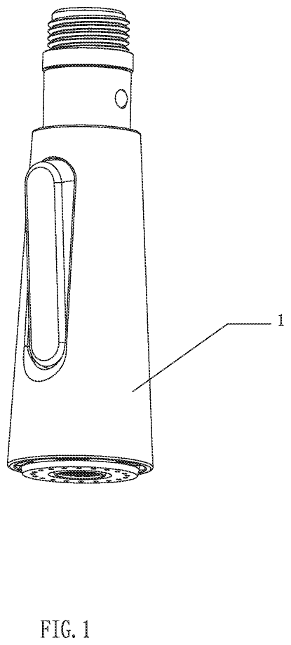

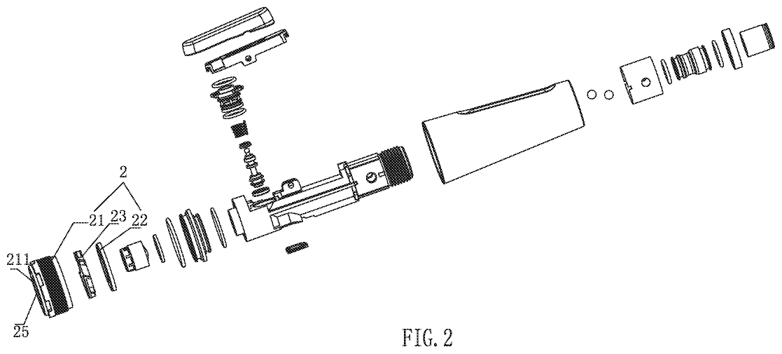

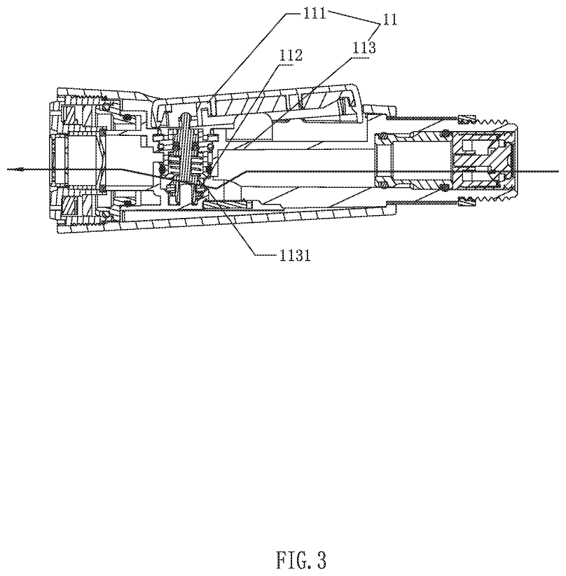

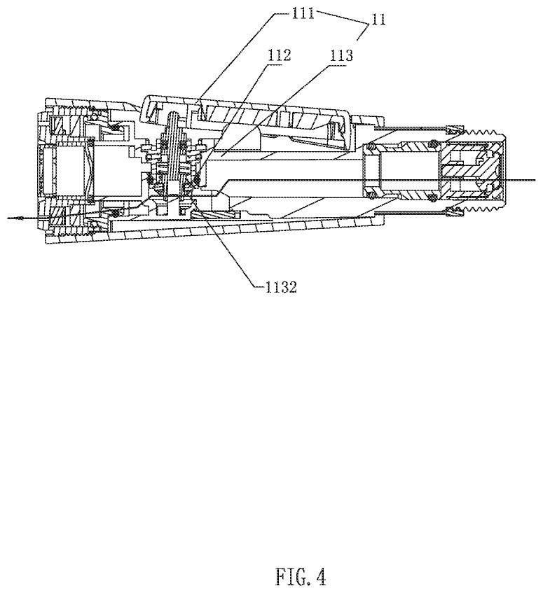

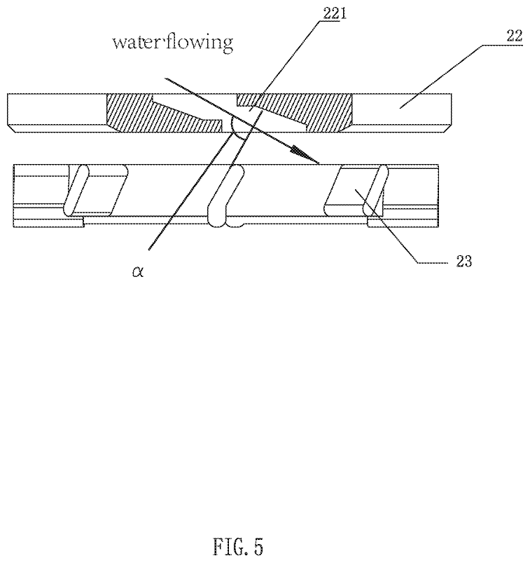

Referring to FIGS. 1-5, a shower head comprises a shower head body 1, the front end of the shower head body 1 is assembled with an outlet device 2.

The outlet device 2 comprises a main body 21 21, a slanting water body 22, a rotating driving element 23 and a blocking element 24;

One side of the main body 21 is the inlet end, the other side is disposed with a plurality of outlet holes 211; the slanting water body 22, the rotating driving element 23 and the blocking element 24 are disposed in the main body 21; the slanting water body 22 is disposed with a slanting outlet hole 221 with one end connected to the inlet end and the other end connected to the rotating driving element 23; so that water flows from the slanting outlet hole 221 to the rotating driving element 23 and drives the rotating driving element 23 to rotate, the rotating driving element 23 drives the blocking element 24 to rotate synchronously; the blocking element 24 blocks a part of the outlet holes 211 during the rotating and makes the position of the outlet holes 211 in outlet state change with the rotation of the blocking element 24, and water flows out of the outlet device in spiral shape to form rhythmic water.

Above shower head is provided that with the outlet device 2, the blocking element 24 blocks a part of the outlet holes 211, so that only a part of outlet holes 211 have water flowing out of the outlet device all the time, and the water outlet portion rotates with the rotation of the blocking element 24 of the impeller to form a dynamic spiral water, namely rhythmic water; as water flows out of only a part of the water outlet holes 211, the impact force of each water hole is stronger; and due to the dynamic effect of the water, the cleaning area of the rhythmic water does not decrease, the rhythmic water has characteristic of intermittent, so the rhythmic water has a vibration function with a better cleaning effect.

In this embodiment, the rotating driving element 23 is an impeller with blades arranged with space in the periphery; the block is a block plate connected between the blades. The block plate forms a acute angle to the blade. Inclining the blades of the impeller can reduce the resistance between the impeller and the water. Another embodiment with independent impeller and the blocking element 24 is a simple replacement of this embodiment.

For the blocking element 24 to block the outlet holes 221, the outlet holes 211 are arranged in a circle, the block plate blocks a half of the outlet holes 211. In actual use, the length of the block plate can be different, making the number of the outlet holes being blocked by the block plate changed, which is a simple replacement of this embodiment.

The intersection angle of the slanting outlet hole 221 and the blade ranges from 70-110°, and the energy of the water flow is maximized to drive the impeller to rotate.

The slanting outlet holes 211 are arranged along the circumferential direction of the slanting water body 22, and the smaller the number of the slanting outlet holes 211 is, the faster the rotation speed of the impeller rotates.

To further increase the outlet type of the shower head and provide the shower head with rhythmic water effect and bubble water effect, the main body 21 of the outlet device is further disposed with a straight flush water outlet 25 at the axial center, and the water outlet holes 211 are distributed at the periphery of the straight flush water outlet 25; water directly flows out of the straight flush water outlet 2.

The straight flush water outlet is disposed with a bubbler to achieve the bubble water effect, and the straight flush water outlet is disposed at the axial center, which is not eccentric, the appearance is attractive.

To achieve switch of rhythmic water and bubble water, the shower head main body further comprises a switch device 11, the switch device 11 comprises an operation element 111, a sealing element 112 and a spindle 113; the spindle 113 is disposed with a first passage 1131 connected to the water flowing hole and a second passage 1132 connected to the slanting outlet holes 211; the operation element 111 drives the sealing element 112 to move to close the first passage 1131 or the second passage 1132.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. An outlet device, wherein comprising a main body, a slanting water body, a rotating driving element and a blocking element;
One side of the main body is the inlet end, the other side is disposed with a plurality of outlet holes; the slanting water body, the rotating driving element and the blocking element are disposed in the main body; the slanting water body is disposed with a slanting outlet hole with one end connected to the inlet end and the other end connected to the rotating driving element;
Water flows from the slanting outlet hole to the rotating driving element and drives the rotating driving element to rotate, the rotating driving element drives the blocking element to rotate synchronously; the blocking element blocks a part of the outlet holes during the rotating and makes the position of the outlet holes in outlet state change with the rotation of the blocking element, and water flows out of the outlet device in spiral shape to form rhythmic water.

2. The outlet device according to claim 1, wherein the rotating driving element is an impeller with blades arranged with space in the periphery; the block is a block plate connected between the blades.

3. The outlet device according to claim 2, wherein the block plate forms a acute angle to the blade.

4. The outlet device according to claim 3, wherein the outlet holes are arranged in a circle, the area of the block plate is a half of the periphery of the external side wall of the water hole, making the block plate blocks a half of the outlet holes.

5. The outlet device according to claim 2, wherein the intersection angle of the slanting outlet hole and the blade ranges from 70-110°.

6. The outlet device according to claim 5, wherein the slanting outlet holes are arranged along the circumferential direction of the slanting water body, and the smaller the number of the slanting outlet holes is, the faster the rotation speed of the impeller rotates.

7. A shower head, comprising a shower head body, wherein the front end of the shower head body is assembled with the outlet device according to claim 4.

8. The shower head according to claim 7, wherein the main body of the outlet device is further disposed with a straight flush water outlet at the axial center, and the water outlet holes are distributed at the periphery of the straight flush water outlet; the center of the impeller and the slanting water body respectively have a water flowing hole, and the water flows out of the straight flush water outlet through the water flowing holes.

9. The shower head according to claim 8, wherein the straight flush water outlet is disposed with a bubbler.

10. The shower head according to claim 7, wherein further comprising a switch device, the switch device comprises an operation element, a sealing element and a spindle; the spindle is disposed with a first passage connected to the water flowing hole and a second passage connected to the slanting outlet holes; the operation element drives the sealing element to move to close the first passage or the second passage.

11. A shower head, comprising a shower head body, wherein the front end of the shower head body is assembled with the outlet device according to claim 5.

12. A shower head, comprising a shower head body, wherein the front end of the shower head body is assembled with the outlet device according to claim 6.

13. The shower head according to claim 11, wherein the main body of the outlet device is further disposed with a straight flush water outlet at the axial center, and the water outlet holes are distributed at the periphery of the straight flush water outlet; the center of the impeller and the slanting water body respectively have a water flowing hole, and the water flows out of the straight flush water outlet through the water flowing holes.

14. The shower head according to claim 12, wherein the main body of the outlet device is further disposed with a straight flush water outlet at the axial center, and the water outlet holes are distributed at the periphery of the straight flush water outlet; the center of the impeller and the slanting water body respectively have a water flowing hole, and the water flows out of the straight flush water outlet through the water flowing holes.

15. The shower head according to claim 13, wherein the straight flush water outlet is disposed with a bubbler.

16. The shower head according to claim 14, wherein the straight flush water outlet is disposed with a bubbler.

17. The shower head according to claim 11, wherein further comprising a switch device, the switch device comprises an operation element, a sealing element and a spindle; the spindle is disposed with a first passage connected to the water flowing hole and a second passage connected to the slanting outlet holes; the operation element drives the sealing element to move to close the first passage or the second passage.

18. The shower head according to claim 12, wherein further comprising a switch device, the switch device comprises an operation element, a sealing element and a spindle; the spindle is disposed with a first passage connected to the water flowing hole and a second passage connected to the slanting outlet holes; the operation element drives the sealing element to move to close the first passage or the second passage.
